(19) United States
(12) Patent Application Publication
(10) Pub. No.: US 2004/0262793 A1
(43) Pub. Date: Dec. 30, 2004

(54) Multi-layered optical recording medium and multi-layered optical recording medium manufacturing method

(76) Inventors: Tetsuro Mizushima, Tokyo (JP); Tsuyoshi Komaki, Tokyo (JP); Jiro Yoshinari, Tokyo (JP)

Correspondence Address: GREENBLUM & BERNSTEIN, P.L.C., 1950 ROLAND CLARKE PLACE, RESTON, VA, 20191, US

(21) Appl. No.: 10/498,977

(22) PCT Filed: Dec. 26, 2002
(86) PCT No.: PCT/JP02/13721

(30) Foreign Application Priority Data
Dec. 27, 2001 (JP) 2001-396090

(51) Int. Cl. B29D 17/00

(52) U.S. Cl. 264/1.33; 430/321; 430/320

(57) ABSTRACT

A multilayer optical recording medium includes a substrate that has grooves for tracking purposes formed on a surface thereof on an incident side for a laser beam, the guide grooves having a recording layer formed on a surface thereof, and a spacer layer that has grooves for tracking purposes formed on a surface thereof, the guide grooves having another recording layer formed on a surface thereof and the spacer layer being formed above the substrate. The respective guide grooves are formed deeper the closer the grooves are positioned to the substrate. By doing so, it is possible to maintain a high signal level for a tracking error signal during a tracking servo for the recording layer that is susceptible to the effects of the thickness distribution of the spacer layer. Accordingly, it is possible to favorably perform the recording and reading of data on the recording layer in the same way as the recording and reading of data on the recording layer.

### TECHNICAL FIELD

The present invention relates to a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, and also relates to a multilayer optical recording medium manufacturing method.

### BACKGROUND ART

As one example of this type of multilayer optical recording medium, a multilayer optical recording medium 31 (which as one example has two layers) shown in FIG. 20 is known. This multilayer optical recording medium 31 is a so-called “single-sided multilayer optical recording medium”, and is constructed of a recording layer L1, a spacer layer SP, a recording layer L0, and a cover layer C that are formed in layers in the stated order on a substrate D in the form of a flat plate (as one example, in a disc shape) that has an attachment center hole formed in a center part. In this case, a fine protrusion/depression pattern (with the depth Ld12) of guide grooves (grooves GR and lands LD) and the like are formed in the cover layer C-side surface of the substrate D. The recording layer L1 is provided on this fine protrusion/depression pattern and is composed of laminated layers such as a reflective film that reflects a recording laser beam and a reproduction laser beam (hereinafter referred to as the “laser beam” when distinction is not required), a phase change film whose light reflectivity changes in accordance with changes in the optical constant due to irradiation with a recording laser beam, and a protective film that protects the phase change film. The spacer layer SP is formed of a light transmitting resin, and has a fine protrusion/depression pattern of grooves GR, lands LD, and the like with a depth Ld02 equal to the depth Ld12 of the fine protrusion/depression pattern formed in the substrate D formed in the surface on the cover layer C side. The recording layer L0 is composed of layers such as a phase change film and a protective film that are laminated on this fine protrusion/depression pattern. The cover layer C is formed of a light transmitting resin. By irradiating this multilayer optical recording medium 31 with a laser beam from an optical pickup in the direction of the arrow A in FIG. 20, the recording of data onto these recording layers L0, L1 or the reading of data from these recording layers L0, L1 is carried out.

Next, the method of manufacturing the multilayer optical recording medium 31 will be described with reference to FIGS. 16 to 20.

When manufacturing this multilayer optical recording medium 31, first a master stamper MSS that has a fine pattern (hereinafter referred to as an “inphase fine protrusion/depression pattern”) with the same orientation as the fine pattern of grooves GR, lands LD, pits, and the like (hereinafter referred to as the “grooves GR and lands LD”) to be formed in the surface of a substrate D is fabricated using a metal material. Next, as shown in FIG. 16, by transferring the fine protrusion/depression pattern formed in the surface of this master stamper MSS, a mother stamper MTS in whose surface a fine protrusion/depression pattern (hereinafter, “reversed fine protrusion/depression pattern”) with a reversed orientation (an orientation with reversed phase) to the fine protrusion/depression pattern of the grooves GR and lands LD is formed is fabricated using a metal material. In this case, since the mother stamper MTS is fabricated of a metal material, the fine protrusion/depression pattern of the mother stamper MTS has the same depth as the fine protrusion/depression pattern of the master stamper MSS but a reversed orientation. In addition, as shown in FIG. 17, by transferring from the mother stamper MTS, a child stamper CHS that has an inphase fine protrusion/depression pattern with the same orientation as the grooves GR and lands LD is fabricated using a metal material. In this case, since the child stamper CHS is fabricated of a metal material, the fine protrusion/depression pattern of the child stamper CHS has the same depth as the fine protrusion/depression pattern of the mother stamper MTS but a reversed orientation.

Next, as shown in FIG. 18, the mother stamper MTS and the child stamper CHS are respectively placed in resin-molding molds (not shown) and the substrate D and the cover layer C in whose surfaces the grooves GR and the lands LD are formed are fabricated by injecting a resin material into the respective molds. In this case, the cover layer C is fabricated using a light- or transmitting resin material. Next, as shown in FIG. 19, the recording layer L1 is formed on the grooves GR and the lands LD of the fabricated substrate D and the recording layer L0 is formed on the surface of the fabricated cover layer C in which the fine protrusion/depression pattern is formed. Finally, as shown in FIG. 20, the substrate D and the cover layer C are arranged with the respective surfaces in which fine protrusion/depression patterns are formed facing one another and are stuck together using an adhesive made of a light transmitting resin material. In this case, the adhesive layer formed by the light transmitting resin adhesive composes the spacer layer SP as a light transmitting layer. In this state, the recording layer L1 on the substrate D and the recording layer L0 on the cover layer C (on the spacer layer SP) have inphase fine protrusion/depression patterns with the same orientation with respect to the orientation of the incident light. Also, at the surface of the spacer layer SP that contacts the cover layer C, the adhesive that is yet to harden assumes the shape of the fine protrusion/depression pattern formed in the cover layer C so that a fine protrusion/depression pattern with a reversed orientation to the pattern of the cover layer C is formed. By the above process, the multilayer optical recording medium 31 is manufactured. It should be noted that although the widths of the respective grooves GR of the substrate D and the spacer layer SP shown in the drawings appear to be different, in reality the widths on both surfaces are substantially equal.

### DISCLOSURE OF THE INVENTION

By investigating the multilayer optical recording medium 31 described above, the inventors discovered the following problem. That is, when the recording of data on the recording layers L0, L1 or the reading of data from the recording layers L0, L1 is carried out for the multilayer optical recording medium 31, a tracking servo is carried out using a tracking error signal outputted from an optical pickup that receives a laser beam that has been reflected by the respective recording layers L0, L1. In this case, the signal level of the tracking error signal is affected by the depth of the lands LD formed in the surfaces of the substrate D and the cover layer C (the spacer layer SP), and in general, within a predetermined range, the signal level of the tracking error signal is larger the deeper the lands LD. More specifically, the following relationship is established between the signal level Ip of the tracking error signal and the depth Ld of the lands LD.

Ip∝ sin(2π·2·n·Ld/λ)

Here, n represents the refractive index of the cover layer C (or the spacer layer SP), and λ represents the laser beam wavelength.

On the other hand, for the multilayer optical recording medium 31, the mother stamper MTS for the substrate D and the child stamper CHS for the cover layer C are produced by transfer from a common master stamper MSS, and are fabricated using a metal material that has superior transfer characteristics and a low rate of shrinkage. In this case, since the respective depths of the fine protrusion/depression patterns that form the grooves GR and the like formed in the respective surfaces of the mother stamper MTS and the child stamper CHS are equal, the depths Ld12, Ld02 of the respective lands LD of the substrate D and the cover layer C (the spacer layer SP) are equal. Accordingly, when focusing on only the depth of the lands LD, it is thought that the signal levels of the tracking error signals outputted from the optical pickup during a tracking servo for the respective recording layers L0, L1 will be equal and the S/N ratio of the tracking error signals outputted from the optical pickup during a tracking servo for the respective recording layers L0, L1 will also be equal. However, in reality the S/N ratio of the tracking error signal during a tracking servo for the recording layer L1 tends to fall corresponding to an amount of the effect made by the thickness distribution of the spacer layer SP. This means that for the multilayer optical recording medium 31, it is harder to carry out a tracking servo for the recording layer L1 than a tracking servo for the recording layer L0, so that there is the problem of the risk that it will not be possible to favorably carry out the recording of data onto the recording layer L1 and the reading of data from the recording layer L1.

The present invention was conceived in view of the problem described above and it is a principal object of the present invention to provide a multilayer optical recording medium for which data can be favorably recorded onto and read from each recording layer and a method of manufacturing this multilayer optical recording medium.

A multilayer optical recording medium according to the present invention includes: a substrate that has guide grooves for tracking purposes formed on a surface thereof on an incident side for a laser beam, the guide grooves having a recording layer formed on a surface thereof; and at least one light transmitting layer that also has guide grooves for tracking purposes formed in respective surfaces thereof, the guide grooves having at least one other recording layer formed on a surface thereof and the at least one light transmitting layer being formed above the substrate, wherein the guide grooves are formed deeper the closer the guide grooves are positioned to the substrate.

In this multilayer optical recording medium, by forming the guide grooves of the light transmitting layer positioned on the incident side for the laser beam the shallowest and forming the guide grooves in the substrate the deepest, it is possible to maintain a high signal level for the tracking error signal during a tracking servo for recording layers that are easily affected by the thickness distribution of the light transmitting layer. Accordingly, since the S/N ratio of the tracking error signal outputted by an optical pickup during a tracking servo for the respective recording layers can be improved, a tracking servo can be favorably carried out for the respective recording layers in the same way as a tracking servo carried out for the recording layer positioned on the incident side for the laser beam in the incident direction. As a result, the recording of data on all of the recording layers and the reading of data from all of the recording layers can be carried out favorably.

A method of manufacturing a multilayer optical recording medium according to the present invention uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, the stamper fabricating step comprising at least a step of fabricating a resin stamper, in which a reversed fine protrusion/depression pattern with a reversed orientation to a protrusion/depression pattern of the guide grooves is formed, by transferring a pattern from a first stamper which is made of metal and in a surface of which a fine protrusion/depression pattern with a same orientation as the protrusion/depression pattern of the guide grooves is formed, and the method of manufacturing comprising at least: as an intermediate step of manufacturing the multilayer optical recording medium, a step of fabricating the substrate, in a surface of which the guide grooves are formed, by transferring a pattern from one of a transfer original metal stamper used when the first stamper is fabricated and a metal stamper fabricated by transferring a pattern from the first stamper; a step of forming the recording layer on the surface of the guide grooves of the fabricated substrate; a step of applying a light transmitting resin onto a surface of the formed recording layer; a step of forming a light transmitting layer, in which the guide grooves are formed, by transferring a pattern from the resin stamper onto a surface of the applied light transmitting resin; and a step of forming the other recording layer on the surface of the guide grooves of the formed light transmitting layer.

With the above method of manufacturing a multilayer optical recording medium according to the present invention, the substrate, in whose surface the guide grooves are formed, is fabricated by transferring a pattern from one of a transfer original metal stamper used when the first stamper is fabricated and a metal stamper fabricated by transferring a pattern from the first stamper, and the light transmitting layer, in which the guide grooves are formed, is fabricated by transferring a pattern from the resin stamper in whose surface a reversed fine protrusion/depression pattern with a reverse orientation to the protrusion/depression pattern of the guide grooves is formed in the stamper fabricating step by transferring a pattern from a first stamper that is made of metal. Therefore, the differences in transfer characteristics and rate of shrinkage of the metal material and the resin material are used so that a multilayer optical recording medium in which the guide grooves in the substrate are definitely deeper than the guide grooves in the light transmitting layer can be manufactured cheaply.

Another method of manufacturing a multilayer optical recording medium according to the present invention uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, the stamper fabricating step comprising at least: a step of fabricating a twelfth stamper, in which a reversed fine protrusion/depression pattern with a reversed orientation to a protrusion/depression pattern of the guide grooves is formed, by transferring a pattern from an eleventh stamper, which is made of metal and in whose surface a fine protrusion/depression pattern with a same orientation as a protrusion/depression pattern of the guide grooves is formed, to a metal material an odd number of times; a step of fabricating a thirteenth stamper, in which a fine protrusion/depression pattern with a same orientation as the protrusion/depression pattern of the guide grooves is formed, by transferring a pattern from the eleventh stamper to a metal material an even number of times; and a step of fabricating a resin stamper, in which a reversed fine protrusion/depression pattern with a reversed orientation to the protrusion/depression pattern of the guide grooves is formed, by transferring a pattern from the thirteenth stamper, and the method of manufacturing comprising at least: as an intermediate step of manufacturing the multilayer optical recording medium, a step of manufacturing the substrate, in whose surface the guide grooves are formed, by transferring a pattern from a twelfth stamper; a step of forming the recording layer on the surface of the guide grooves in the fabricated substrate; a step of applying a light transmitting resin onto a surface of the formed recording layer; a step of forming a light transmitting layer in which the guide grooves are formed by transferring a pattern from the resin stamper onto a surface of the applied light transmitting resin; and a step of forming the other recording layer on the surface of the guide grooves of the formed light transmitting layer.

With the above method of manufacturing a multilayer optical recording medium according to the present invention, the substrate, in whose surface the guide grooves are formed, is fabricated by transferring a pattern from a twelfth stamper fabricated using a single eleventh stamper made of metal and guide grooves are formed in the surface of the light transmitting layer by transferring a pattern from a resin stamper fabricated by transferring a pattern from a thirteenth stamper. Accordingly, even though there is only one eleventh stamper, the differences in transfer characteristics and rate of shrinkage of the metal material and the resin material are used so that a multilayer optical recording medium in which the guide grooves in the substrate are deeper than the guide grooves in the light transmitting layer can be manufactured reliably and cheaply.

Another method of manufacturing a multilayer optical recording medium according to the present invention uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, the stamper fabricating step comprising at least: a step of fabricating a twenty-second stamper, in which a fine protrusion/depression pattern with a same orientation as a protrusion/depression pattern of the guide grooves is formed, by transferring a pattern from a twenty-first stamper, which is made of metal and in a surface of which a reversed fine protrusion/depression pattern with a reversed orientation to the protrusion/depression pattern of the guide grooves is formed, an odd number of times onto a metal material; a step of fabricating a twenty-third stamper, in which a reversed fine protrusion/depression pattern with a reversed orientation to the protrusion/depression pattern of the guide grooves is formed, by transferring a pattern an even number of times from the twenty-first stamper to a metal material; and a step of manufacturing a resin stamper, in which a reversed fine protrusion/depression pattern with a reversed orientation to the protrusion/depression pattern of the guide grooves is formed, by transferring a pattern from the twenty-second stamper, and the method of manufacturing comprising at least: as an intermediate step of manufacturing the multilayer optical recording medium, a step of manufacturing the substrate, in whose surface the guide grooves are formed, by transferring a pattern from a twenty-third stamper; a step of forming the recording layer on the surface of the guide grooves in the fabricated substrate; a step of applying a light transmitting resin onto a surface of the formed recording layer; a step of forming a light transmitting layer, in which the guide grooves are formed, by transferring a pattern from the resin stamper onto a surface of the applied light transmitting resin; and a step of forming the other recording layer on the surface of the guide grooves of the formed light transmitting layer.

With the above method of manufacturing a multilayer optical recording medium according to the present invention, the substrate, in whose surface the guide grooves are formed, is fabricated by transferring a pattern from a single twenty-first stamper made of metal or a twenty-third stamper fabricated using the twenty-first stamper, and guide grooves are formed in the surface of the light transmitting layer using a resin stamper fabricated by transferring a pattern from a twenty-second stamper fabricated by transferring a pattern from the twenty-first stamper, so that even though there is only one twenty-first stamper, the differences in transfer characteristics and rate of shrinkage of the metal material and the resin material are used so that a multilayer optical recording medium in which the guide grooves in the substrate are deeper than the guide grooves in the light transmitting layer can be manufactured reliably and cheaply.

Another method of manufacturing a multilayer optical recording medium according to the present invention uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate, the stamper fabricating step comprising at least a step of fabricating a resin stamper, in which a reversed fine protrusion/depression pattern with a reversed orientation to the protrusion/depression pattern of the guide grooves is formed, by transferring a pattern from a thirty-second stamper, which is made of metal and in a surface of which a fine protrusion/depression pattern with a same orientation as the protrusion/depression pattern of the guide grooves is formed more shallowly than a fine protrusion/depression pattern of a thirty-first stamper, which is made of metal and in which a reversed fine protrusion/depression pattern with a reversed orientation to the protrusion/depression pattern of the guide grooves is formed, and the method of manufacturing comprising at least: as an intermediate step of manufacturing the multilayer optical recording medium, a step of fabricating the substrate, in whose surface the guide grooves are formed, by transferring a pattern from a thirty-first stamper; a step of forming the recording layer on the surface of the guide grooves in the fabricated substrate; a step of applying a light transmitting resin onto a surface of the formed recording layer; a step of forming a light transmitting layer, in which the guide grooves are formed, by transferring a pattern from the resin stamper onto a surface of the applied light transmitting resin; and a step of forming the other recording layer on the surface of the guide grooves of the formed light transmitting layer.

With the above method of manufacturing a multilayer optical recording medium according to the present invention, a thirty-first stamper and a thirty-second stamper which are made of metal and whose protrusion/depression patterns for guide grooves differ in depth and orientation are used. The substrate, in whose surface the guide grooves are formed, is fabricated by transferring a pattern from the thirty-first stamper, and guide grooves are formed in the surface of the light transmitting layer by transferring a pattern from a resin stamper fabricated by transferring a pattern from a thirty-second stamper, so that the depth of the guide grooves of the substrate and the depth of the guide grooves of the light transmitting layer can be set freely and independently. As a result, with this method of manufacturing a multilayer optical recording medium also, it is possible to manufacture a multilayer optical recording medium for which a more favorable S/N ratio can be achieved for the tracking error signal during a tracking servo on every recording layer.

It should be noted that although in the intermediate step of the above method of manufacturing a multilayer optical recording medium according to the present invention, the light transmitting layer on whose surface are formed the guide grooves for tracking purposes, which in turn have a recording layer formed on a surface thereof, is formed by a single resin layer fabricated by carrying out a step of applying a light transmitting resin onto the surface of the recording layer formed on the substrate and a step of forming the light transmitting layer, in which the guide grooves are formed, by transferring a pattern from the resin stamper to the surface of the applied light transmitting resin, it is also possible to form the light transmitting layer of two or more resin layers using the substrate and the resin stamper used in the step described above. The method of manufacturing the light transmitting layer in this case carries out at least a step of forming a light transmitting layer (the first layer), in which the guide grooves are formed, by applying the light transmitting resin onto the resin stamper and transferring a pattern from the resin stamper to the surface of the light transmitting resin, a step of applying a light transmitting adhesive resin (the second layer) onto the recording layer formed on the substrate, and a step of sticking together (attaching) the substrate and the light transmitting layer, in which the guide grooves are formed, with the respective resins facing each other.

Another method of manufacturing a multilayer optical recording medium composed of a substrate that has guide grooves for tracking purposes formed on a surface thereof on an incident side for a laser beam, the guide grooves having a recording layer formed on a surface thereof, a light transmitting layer that also has guide grooves for tracking purposes formed in a surface thereof, the guide grooves having another recording layer formed on a surface thereof, and a cover layer that transmits light, the light transmitting layer and the cover layer being formed above the substrate, the method of manufacturing comprising at least: as an intermediate step of manufacturing the multilayer optical recording medium, a step of manufacturing the substrate, in whose surface the guide grooves are formed, by transferring a pattern from a forty-first stamper which is made of metal and in which a reversed fine protrusion/depression pattern with a reversed orientation to a protrusion/depression pattern of the guide grooves is formed; a step of fabricating the cover layer, in which a reversed fine protrusion/depression pattern with a reversed orientation to a protrusion/depression pattern of the guide grooves is formed, by transferring a pattern from a forty-second stamper, which is made of metal and in which a fine protrusion/depression pattern with a same orientation as the protrusion/depression pattern of the guide grooves is formed shallower than the reversed fine protrusion/depression pattern of the forty-first stamper; a step of forming the respective recording layers on the surface of the guide grooves formed in the fabricated substrate and the surface of the reversed fine protrusion/depression pattern of the fabricated cover layer; and a step of integrating, via a light transmitting adhesive resin as the light transmitting layer, the substrate and the cover layer in a state where the respective recording layers thereon face one another, and transferring a pattern of the cover layer to a surface of the light transmitting adhesive resin to form the guide grooves.

With this method of manufacturing the multilayer optical recording medium according to the present invention, the forty-first stamper and the forty-second stamper, which are made of metal and whose protrusion/depression patterns of guide grooves differ in depth and orientation, are used. The substrate, in whose surface the guide grooves are formed, is fabricated by transferring a pattern from the forty-first stamper and the cover layer, in whose surface a reversed fine protrusion/depression pattern is formed, is fabricated by transferring a pattern from the forty-second stamper. By forming recording layers on the respective surfaces of the guide grooves of the substrate and the reversed fine protrusion/depression pattern of the cover layer, integrating the substrate and the cover layer via a light transmitting adhesive resin as the light transmitting layer with the respective recording layers facing one another, and forming guide grooves in the surface of the light transmitting adhesive resin at this time, it is possible to set the depths of the guide grooves in the substrate and the depth of the guide grooves in the light transmitting layer freely and independently. As a result, it is possible to manufacture a multilayer optical recording medium for which a more favorable S/N ratio can be achieved for the tracking error signal during a tracking servo on every recording layer.

It should be noted that the disclosure of the present invention relates to a content of Japanese Patent Application 2001-396090 that was filed on 27 Dec. 2001 and the entire content of which is herein incorporated by reference.

### BRIEF DESCRIPTION OF THE DRAWINGS

FIG. 1 is a side cross-sectional view taken when a mother stamper MTS is fabricated from a master stamper MSS.

FIG. 2 is a side cross-sectional view taken when a child stamper CHS is fabricated from the mother stamper MTS (MTS1).

FIG. 3 is a side cross-sectional view taken when a resin stamper RS is fabricated from the child stamper CHS.

FIG. 4 is a side cross-sectional view taken when a substrate D is fabricated using a mother stamper MTS (MTS2).

FIG. 5 is a side cross-sectional view of the substrate D on whose surface a recording layer L1 has been formed.

FIG. 6 is a side cross-sectional view of a state where an applied liquid R has been applied onto the substrate D by spin coating.

FIG. 7 is a side cross-sectional view of a state where the resin stamper RS has been placed on the substrate D on which the applied liquid R has been applied.

FIG. 8 is a side cross-sectional view of a state where a spacer layer SP has been fabricated by hardening the applied liquid R and then separating the resin stamper RS.

FIG. 9 is a side cross-sectional view showing the multilayer optical recording media 1, 11.

FIG. 10 is a side cross-sectional view taken when the substrate D is fabricated from a mother stamper MTS11 and a cover layer C is fabricated from a child stamper CHS11.

FIG. 11 is a side cross-sectional view of a state where the recording layer L1 has been formed on the surface of the substrate D and the recording layer L0 has been formed on the surface of the cover layer C.

FIG. 12 is a side cross-sectional view of a state where, in another fabrication process for the spacer layer SP, an applied liquid R1 has been applied onto the stamper RS by spin coating and hardened.

FIG. 13 is a side cross-sectional view of a state where, in another fabrication process for the spacer layer SP, an applied liquid R2 has been applied onto the substrate D by spin coating.

FIG. 14 is a side cross-sectional view of a state where the stamper RS shown in FIG. 12 has been placed on the substrate D in the state shown in FIG. 13 and the applied liquid R2 has been hardened.

FIG. 15 is a side cross-sectional view of a state where the stamper RS has been separated from the state shown in FIG. 14 to fabricate the spacer layer SP.

FIG. 16 is a side cross-sectional view of a state where the mother stamper MTS is fabricated from the master stamper MSS.

FIG. 17 is a side cross-sectional view of a state where the child stamper CHS is fabricated from the mother stamper MTS.

FIG. 18 is a side cross-sectional view taken when the substrate D is fabricated from a mother stamper MTS and the cover layer C is fabricated from the child stamper CHS.

FIG. 19 is a side cross-sectional view of a state where the recording layer L1 has been formed on the surface of the substrate D and the recording layer L0 has been formed on the surface of the cover layer C.

FIG. 20 is a side cross-sectional view showing the construction of a multilayer optical recording medium 31.

### BEST MODE FOR CARRYING OUT THE INVENTION

Preferred embodiments of a multilayer optical recording medium and a multilayer optical recording medium manufacturing method according to the present invention will now be described with reference to the attached drawings.

First, the construction of a multilayer optical recording medium 1 (as one example, a two-layer medium) will be described with reference to FIG. 9.

The multilayer optical recording medium 1 is a so-called single-sided multilayer optical recording medium (a rewritable optical recording medium) equipped with a plurality of phase-change recording layers, for example, and is composed of at least a substrate D, a recording layer L1, a spacer layer SP, a recording layer L0, and a cover layer C. The substrate D is formed in a plate-like shape (as one example, a disc shape) with resin (for example, polycarbonate) as the material. On one surface of the substrate D (the upper surface in FIG. 9), grooves GR and lands LD for guiding a laser beam are formed in spirals as a fine protrusion/depression pattern from a central periphery of the substrate D towards an outer edge. Also, for this substrate D, the depth Ld11 of the lands LD is set deeper than the depth Ld01 of the lands LD formed in the spacer layer SP by around 0.5 to 5 nm, for example. The recording layer L1 is composed by forming a reflective film, a phase change film, a protective film, and the like in layers above the grooves GR and lands LD formed in the surface of the substrate D. In this case, the phase change film is formed of a thin film for example by sputtering to deposit a phase change material such as GeTeSb, InSbTe, or AgGeInSbTe.

The spacer layer SP is formed of a light transmitting resin, and has grooves GR, lands LD, and the like formed in a cover layer C-side surface thereof. In this case, the depth Ld01 of the lands LD formed in the spacer layer SP is set equal to the depth Ld02 of lands LD formed in the surface of the cover layer C (the spacer layer SP) of the conventional multilayer optical recording medium 31 so that a tracking error signal with a favorable S/N ratio is obtained during a tracking servo. The recording layer L0 is composed by laminating a phase change film, a protective film, and the like above the grooves GR and lands LD formed in the surface of the spacer layer SP. In this case, the phase change film of the recording layer L0 is formed of the same construction as the phase change film of the recording layer L1. The cover layer C is a layer that protects the recording layer L0 from scratches and also acts as part (a lens) of an optical path, and is formed by spin coating the recording layer L0 with an applied liquid RC for a light transmitting resin and hardening the applied liquid RC. With this multilayer optical recording medium 1, the recording layers L1, L0 are irradiated in the direction shown by the arrow A in FIG. 9 by a recording laser beam (for example, a laser beam with a wavelength of 405 nm) generated by an optical pickup to reversibly cause phase changes between an amorphous state and a crystal state so that recording marks are recorded and erased. More specifically, when the recording layers L1, L0 are irradiated with a recording laser beam, the irradiated parts are heated to the melting point or above and then cooled (rapidly cooled) to enter an amorphous state, so that recording marks are formed in accordance with binary recording data. Also, when irradiation is carried out with the recording laser beam, irradiated parts of the recording layers L1, L0 are heated to the crystallization temperature or above and then cooled (gradually cooled) so as to be crystallized, thereby deleting the recording marks. In addition, by carrying out irradiation in the direction of the arrow A in FIG. 9 with a reproduction laser beam emitted from the optical pickup, data is read from the recording layers L0, L1.

In this way, with the multilayer optical recording medium 1, by forming the depth Ld11 of the lands LD of the substrate D deeper than the depth Ld of the lands LD of the spacer layer SP, it is possible to maintain a higher signal level of the tracking error signal during a tracking servo for the recording layer L1 that is easily affected by the thickness distribution of the spacer layer SP. Since it is possible to improve the S/N ratio of the tracking error signal outputted from the optical pickup during a tracking servo for the recording layer L1, it is possible to favorably carry out a tracking servo for the recording layer L0 in the same way as a tracking servo for the recording layer L0. Accordingly, it is possible to favorably record and read recording data onto and from the respective recording layers L0, L1.

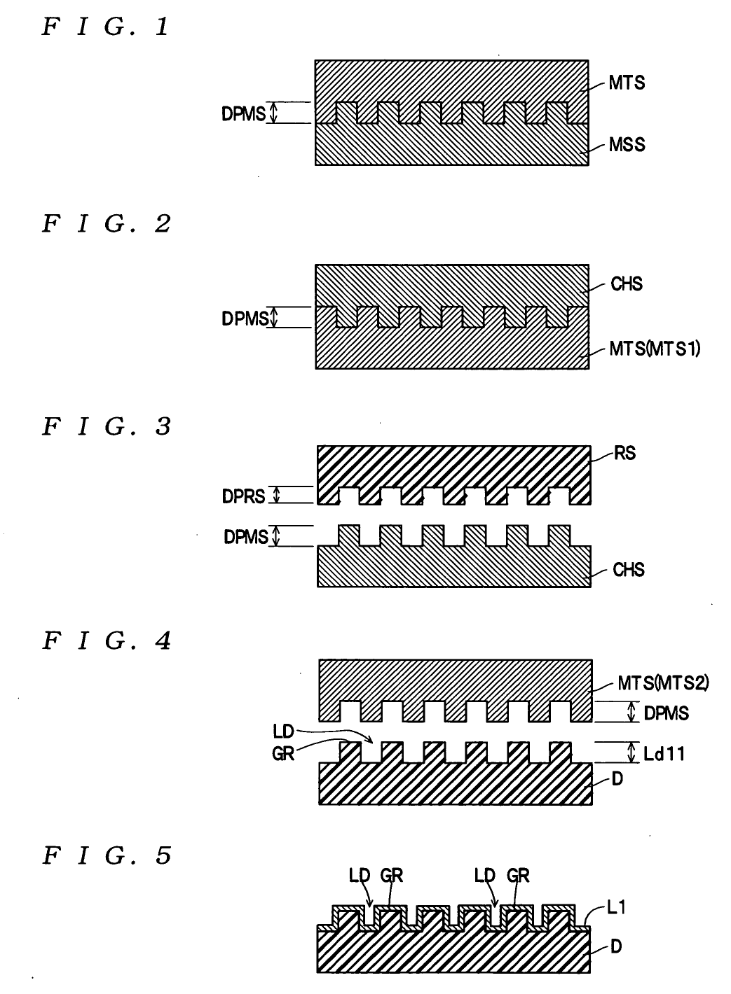

Next, a method of manufacturing the multilayer optical recording medium 1 will be described with reference to FIG. 1 to FIG. 9.

First, when manufacturing the multilayer optical recording medium 1, a “stamper fabricating step” for the present invention is carried out. In this process, a master stamper MSS that is a so-called “matrix” and corresponds to an eleventh stamper for the present invention is fabricated by cutting, in a surface of a metal flat plate (as one example, a metal disc), an inphase fine protrusion/depression pattern with the same orientation as the fine protrusion/depression pattern of the grooves GR and lands LD to be formed in the surface of the substrate D. It should be noted that although not shown, it is possible to use the following method when fabricating the master stamper MSS. A resist layer is formed on the surface of a flat plate made of glass and an exposure/developing process (a patterning process) is carried out on this resist layer to form a reversed fine protrusion/depression pattern, which has a reversed orientation to the fine protrusion/depression pattern of the grooves GR and the lands LD, in the surface of the flat glass plate. A metal layer is then formed by a metal plating process on the surface of the flat glass plate in which this reversed fine protrusion/depression pattern has been formed. This metal layer is then separated from the flat glass plate to fabricate the master stamper MSS. Also, a metal mother stamper MTS that has a reversed fine protrusion/depression pattern, which has a reversed orientation to the fine protrusion/depression pattern of the grooves GR and lands LD, is fabricated using the master stamper MSS. When a separate metal stamper is fabricated from an original metal stamper in this or a later process, transfer is carried out using a normal plating method that uses nickel (Ni) or the like. Accordingly, when transferring a pattern from a metal stamper to another metal stamper, there are favorable transfer characteristics and shrinkage is negligible, so that although the transferred fine protrusion/depression pattern is the reverse of the fine protrusion/depression pattern of the metal stamper used as the original, the depth of the fine protrusion/depression pattern is the same. Also, when fabricating a mother stamper MTS from the master stamper MSS, since it is sufficient to reverse the orientation of the fine protrusion/depression pattern, instead of transferring the pattern once, it is also possible to fabricate a mother stamper MTS by transferring the pattern an odd number of times. It should be noted that the mother stamper MTS composes a twelfth stamper for the present invention.

A child stamper CHS that is made of metal and has an inphase fine protrusion/depression pattern formed in a surface thereof is fabricated using the mother stamper MTS. In this case, the child stamper CHS composes a thirteenth stamper for the present invention. It should be noted that when the child stamper CHS is fabricated from the mother stamper MTS, for the same reason as above, since it is sufficient to reverse the orientation of the fine protrusion/depression pattern, instead of transferring the pattern once, it is also possible to fabricate a child stamper CHS by transferring the pattern from the mother stamper MTS an odd number of times. Also, a stamper RS which is made of resin and has a reversed fine protrusion/depression pattern formed in a surface thereof is also fabricated using the child stamper CHS, and this stamper RS is used to form a fine protrusion/depression pattern of the grooves GR and lands LD in the surface of the spacer layer SP. In this case also, for the same reason as above, since it is sufficient to reverse the orientation of the fine protrusion/depression pattern, it is possible to fabricate the resin stamper RS by transferring from a metal stamper produced by transferring the pattern from the child stamper CHS an even number of times. The fabrication concept for the respective stampers described above also applies when fabricating various stampers that will be described later. In addition, since the master stamper MSS and the child stamper CHS are both metal stampers with fine protrusion/depression patterns of the same orientation and depth, when the child stamper CHS is thought of as a first stamper for the present invention, the mother stamper MTS composes a “transfer original (i.e., the original when transferring patterns) metal stamper used when the first stamper is fabricated” for the present invention.

On the other hand, it is preferable for the S/N ratio of the tracking error signal outputted from the optical pickup during a tracking servo for the recording layer L0 of the multilayer optical recording medium 1 to be set approximately equal to the S/N ratio of the tracking error signal outputted from the optical pickup during a tracking servo for the recording layer L0 of the conventional multilayer optical recording medium 31. Accordingly, the depth Ld01 of the lands LD formed in the surface of the spacer layer SP of the multilayer optical recording medium 1 is set equal to (or approximately equal to) the depth Ld02 of the lands LD formed in the surface of the spacer layer SP of the multilayer optical recording medium 31. On the other hand, when manufacturing the multilayer optical recording medium 1, the resin stamper RS is used to form the grooves GR of the spacer layer SP. In this case, when fabricating the stamper RS from the child stamper CHS, the resin stamper RS shrinks at a rate unique to the resin material used to manufacture the stamper RS. Also, the lands LD become shallow due to the transfer characteristics when the spacer layer SP is fabricated from the resin stamper. Accordingly, in view of the rate of shrinkage of the resin stamper RS and the transfer characteristics from the resin stamper RS to the spacer layer SP, the master stamper MSS is subjected to a cutting process that makes the depth Ld01 of the lands LD formed in the surface of the spacer layer SP of the multilayer optical recording medium 1 equal to (or approximately equal to) the depth Ld02 of the lands LD formed in the surface of the spacer layer SP of the multilayer optical recording medium 31. More specifically, during the cutting process for the master stamper MSS, the depth DPMS of the grooves in the fine protrusion/depression pattern is set so as to be deeper, by around 0.5 to 5 nm for example, than the grooves in the fine protrusion/depression pattern formed in the master stamper MSS used when manufacturing the multilayer optical recording medium 31.

Next, as shown in FIG. 1, the mother stamper MTS in whose surface the reversed fine protrusion/depression pattern is formed (transferred) is fabricated from a metal material using the master stamper MSS. In this case, the metal material has favorable transfer characteristics and a negligible rate of shrinkage, so that the mother stamper MTS is formed with a fine protrusion/depression pattern that has the approximately the same depth DPMS as the fine protrusion/depression pattern of the master stamper MSS.

Next, as shown in FIG. 2, the child stamper CHS, in whose surface an inphase fine protrusion/depression pattern, which has the same orientation as the master stamper MSS but the reversed orientation to the fine protrusion/depression pattern of the mother stamper MTS is formed (transferred), is fabricated from a metal material using the mother stamper MTS. In this case, the child stamper CHS is fabricated using a metal material in the same way as the mother stamper MTS, so that the inphase fine protrusion/depression pattern formed in the surface of the child stamper CHS has approximately the same depth DPMS as the fine protrusion/depression pattern of the master stamper MSS.

Next, as shown in FIG. 3, the stamper RS, which is made of resin (for example, an acrylic resin or an olefin resin) and in whose surface a reversed fine protrusion/depression pattern, which has the same orientation as the mother stamper MTS but the reversed orientation to the fine protrusion/depression pattern of the child stamper CHS, is formed (transferred), is fabricated from a light transmitting resin using the child stamper CHS. In this case, the transfer characteristics of the resin material are inferior to the transfer characteristics of the metal materials, and the rate of shrinkage (in this example, 0.5 to 1.5%) is much higher than the rate of shrinkage (in this example, almost 0%) of the metal materials used in the plating process. For this reason, the stamper RS is fabricated so that the depth DPRS of the fine protrusion/depression pattern formed in the surface thereof for forming the grooves GR and lands LD is shallower than the depth DPMS of the fine protrusion/depression pattern of the child stamper CHS.

Next, the mother stamper MTS is set in a resin-molding mold and a resin material (for example, PC (polycarbonate)) is injected into the mold to fabricate the substrate D in whose surface guide grooves for the grooves GR and lands LD have been formed (transferred), as shown in FIG. 4. In this case, the depth of the fine protrusion/depression pattern formed in the surface of the mother stamper MTS is approximately equal to the depth DPMS of the fine protrusion/depression pattern of the master stamper MSS and the depth DPMS of the fine protrusion/depression pattern of the master stamper MSS is deeper than the fine protrusion/depression pattern formed in the master stamper MSS used when manufacturing the multilayer optical recording medium 31. Also, since the rate of shrinkage of the PC used as the resin is 0.5 to 1.5%, the depth DPMS is set in anticipation of a corresponding reduction of the depth of the fine protrusion/depression pattern of the substrate D, so that the depth Ld11 of the lands LD formed in the surface of the substrate D is formed deeper than the depth Ld12 of the lands LD formed in the surface of the substrate D of the multilayer optical recording medium 31. Next, as shown in FIG. 5, the recording layer L1 is provided (formed) by sputtering, for example, on the surface of the fabricated substrate D in which the fine protrusion/depression pattern has been formed.

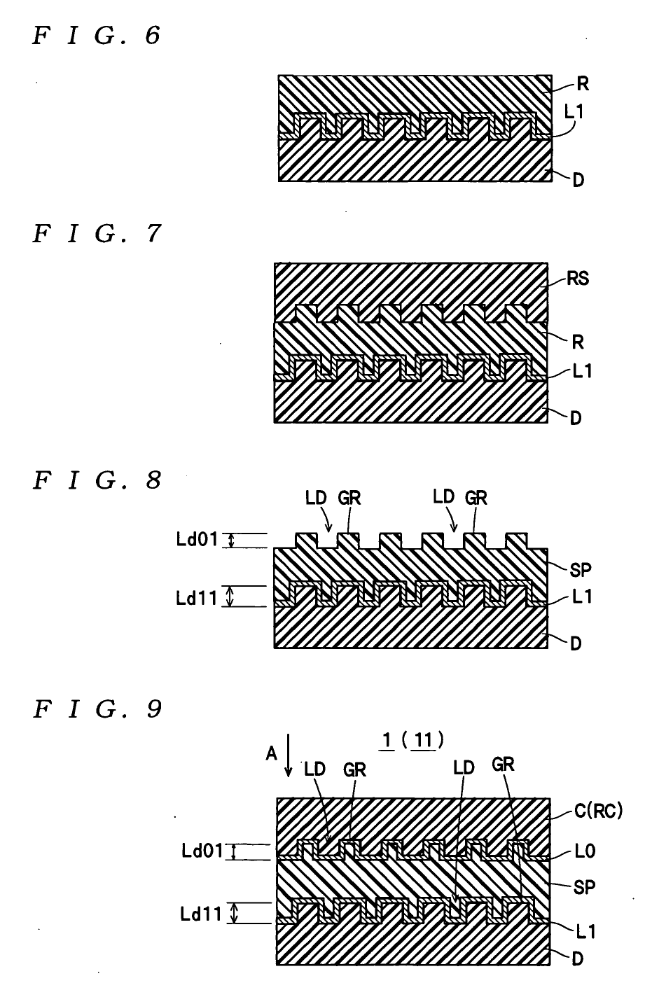

Next, as shown in FIG. 6, an applied liquid R for a light transmitting resin is dripped onto the surface of the substrate D on which the recording layer L1 has been formed and spin coating is carried out to apply a thin film of the applied liquid R across the entire surface region of the substrate D. Next, as shown in FIG. 7, the resin stamper RS is placed over the substrate D on which the applied liquid R has been applied with the surface of the resin stamper RS on which the fine protrusion/depression pattern is formed facing the applied liquid R. In this case, when the application on the substrate D is complete, the applied liquid R still exhibits fluidity and so assumes the shape of the fine protrusion/depression pattern of the surface of the stamper RS while spreading out within the entire gap between the stamper RS and the substrate D.

Next, the applied liquid R is hardened. More specifically, when a UV curable resin is used as the applied liquid R, the applied liquid R is irradiated with UV rays from the stamper RS side to harden the applied liquid R. At this time, in accordance with the transfer characteristics from the resin stamper RS to the spacer layer SP (due to factors such as the rate of shrinkage of the UV curable resin used and the contact pressure between the UV curable resin and the resin stamper), the depth of the lands LD formed in the spacer layer SP is 2 to 10% shallower than the depth of the fine protrusion/depression pattern of the resin stamper RS. Next, as shown in FIG. 8, the stamper RS is separated from the substrate D. By doing so, the spacer layer SP in whose surface the fine protrusion/depression pattern of grooves GR and lands LD has been formed (transferred) is completed. In this case, the lands LD (guide grooves) of the substrate D are formed shallower in accordance with the rate of shrinkage of the polycarbonate used as the resin. On the other hand, in addition to the resin shrinking during the fabrication of the stamper RS so that the reversed fine protrusion/depression pattern of the stamper RS becomes shallow, the transfer characteristics from the stamper RS when forming the spacer layer SP cause the lands LD of the spacer layer SP to be formed even shallower. Accordingly, when the shrinkage of the resin during the fabrication of the substrate D and the shrinkage of the resin during the fabrication of the stamper RS are about the same, the lands LD of the spacer layer SP are definitely formed with a depth Ld01 that is shallower than the depth Ld11 of the lands LD of the substrate D by an amount caused by the transfer characteristics from the stamper RS and is also equal to (or approximately equal) to the depth Ld02 of the lands LD formed in the surface of the spacer layer SP of the multilayer optical recording medium 31.

Next, as shown in FIG. 9, the recording layer L0 is formed by sputtering, for example, on the surface of the formed spacer layer SP on which the fine protrusion/depression pattern has been formed. The process described thusfar corresponds to an “intermediate step” for the present invention. After this, the recording layer L0 is spin coated with the applied liquid RC and the applied liquid RC is hardened to form the cover layer C. By doing so the manufacturing of the multilayer optical recording medium 1 is completed.

In this way, according to the method of manufacturing this multilayer optical recording medium, even if there is only one master stamper MSS, by making use of the differences in transfer characteristics and rate of shrinkage between the metal materials and the resin materials, it is possible to make the depth Ld11 of the lands LD of the substrate D definitely deeper than the depth Ld01 of the lands of the spacer layer SP, so that it is possible to cheaply manufacture a multilayer optical recording medium 1 where the fine protrusion/depression pattern of the recording layer L1 is definitely deeper than the fine protrusion/depression pattern of the recording layer L0.

It should be noted that the present invention is not limited to the above embodiment and can be modified as appropriate. For example, as the master stamper, it is also possible to use a metal stamper (that corresponds to a twenty-first stamper for the present invention) in whose surface a reversed fine protrusion/depression pattern with a reversed orientation to the protrusion/depression pattern of the guide grooves in the substrate D has been formed. According to this method of manufacturing, a mother stamper (that corresponds to a twenty-second stamper for the present invention), in which a fine protrusion/depression pattern with the same orientation as the protrusion/depression pattern of the guide grooves in the substrate D has been formed, is fabricated by transferring a pattern from the master stamper an odd number of times to a metal material, and a child stamper (that corresponds to a twenty-third stamper for the present invention), in which a reversed fine protrusion/depression pattern with a reversed orientation to the protrusion/depression pattern of the guide grooves has been formed, is fabricated by transferring a pattern from the master stamper. In this case, a child stamper is fabricated by transferring a pattern from the master stamper an even number of times according to a separate manufacturing process to the manufacturing process of the mother stamper. Next, the substrate D is fabricated by transferring a pattern from the child stamper or the master stamper, and a resin stamper, in which a reversed fine protrusion/depression pattern with a reversed orientation to the protrusion/depression pattern of the guide grooves is formed, is fabricated by transferring a pattern from the mother stamper. After this, the multilayer optical recording medium 1 is manufactured by the same manufacturing process as described above. With this method of manufacturing also, it is possible to cheaply manufacture a multilayer optical recording medium 1 where the depth Ld11 of the lands LD of the substrate D is deeper than the depth Ld01 of the lands LD of the spacer layer SP and the depth of the fine protrusion/depression pattern in the recording layer L1 is deeper than the fine protrusion/depression pattern in the recording layer L0.

In addition, in this embodiment, when the mother stamper is the first stamper for the present invention, the master stamper composes a “transfer original metal stamper used when the first stamper is fabricated” for the present invention, and the child stamper composes a “metal stamper fabricated by transferring a pattern from the first stamper” for the present invention. That is, the master stamper and the child stamper are both metal stampers and have fine protrusion/depression patterns with the same orientation and depth, while compared to the master stamper and the child stamper, the mother stamper is also a metal stamper and has a fine protrusion/depression pattern with the same depth but with a different orientation. Accordingly, with the present invention, in the methods of manufacturing the embodiments described above and the methods of manufacturing that will be described later, so long as a reversed fine protrusion/depression pattern is formed in a metal stamper for transferring the guide grooves (the grooves GR and lands LD) of the substrate D and a reversed fine protrusion/depression pattern is formed in the resin stamper, a metal stamper for transferring guide grooves of the substrate D and a resin stamper can be fabricated using any of the master stamper, the mother stamper, the child stamper, or a metal stamper fabricated by transferring a pattern an odd or even number of times from these stampers. It should be noted that as described in a later embodiment, it is possible to use two types of master stamper in place of the two types of child stamper in a method of manufacturing that uses two types of master stamper.

It is also possible to use a method that fabricates two types of master stamper MSS1, MSS2 with inphase fine protrusion/depression patterns of different depths and uses both master stampers MSS1, MSS2 to manufacture a multilayer optical recording medium 1 where the depth Ld11 of the lands LD of the substrate D is deeper than the depth Ld01 of the lands LD of the spacer layer SP. More specifically, using both master stampers MSS1, MSS2, two master stampers MTS1, MTS2, in whose surfaces reversed fine protrusion/depression patterns of different depths have been formed, are fabricated from a metal material. Next, as shown in FIG. 2, using the first mother stamper MTS1, which out of the two fabricated mother stampers MTS1, MTS2 has the shallower reversed protrusion/depression pattern, a child stamper CHS in whose surface an inphase fine protrusion/depression pattern has been formed (transferred), is fabricated from a metal material. In this case, the child stamper CHS composes a thirty-second stamper for the present invention.

Next, as shown in FIG. 3, the child stamper CHS is used to fabricate a resin stamper RS. Next, as shown in FIG. 4, the mother stamper MTS2, which has a deeper reversed fine protrusion/depression pattern than the mother stamper MTS1, is set in a resin molding mold and the substrate D is fabricated by injecting a resin material into the mold. In this case, the second mother stamper MTS2 composes the thirty-first stamper for the present invention. After this, in the same way as the method of manufacturing the multilayer optical recording medium described above, the multilayer optical recording medium 1 is manufactured by carrying out the processes in FIG. 5 to FIG. 9. According to this method of manufacturing, although the manufacturing cost rises corresponding to the use of the two types of master stamper MSS1, MSS2, it is possible to set the depth Ld11 of the lands LD of the substrate D and the depth Ld01 of the lands LD of the spacer layer SP independently as desired. Accordingly, it is possible to keep the S/N ratio of the tracking error signal during tracking servos for the respective recording layers L1, L0 in a more favorable state.

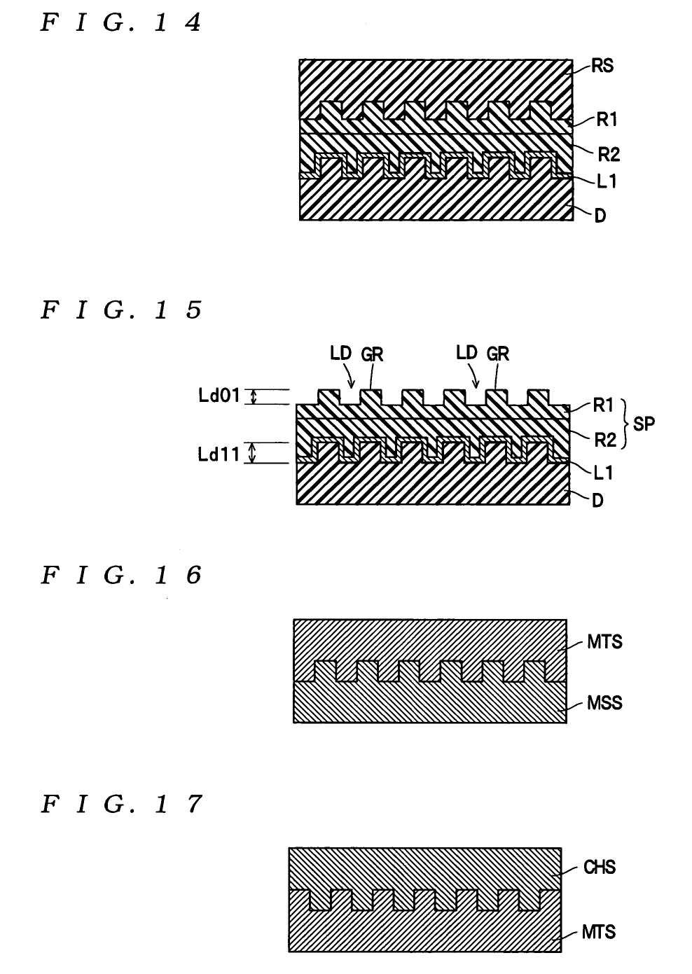

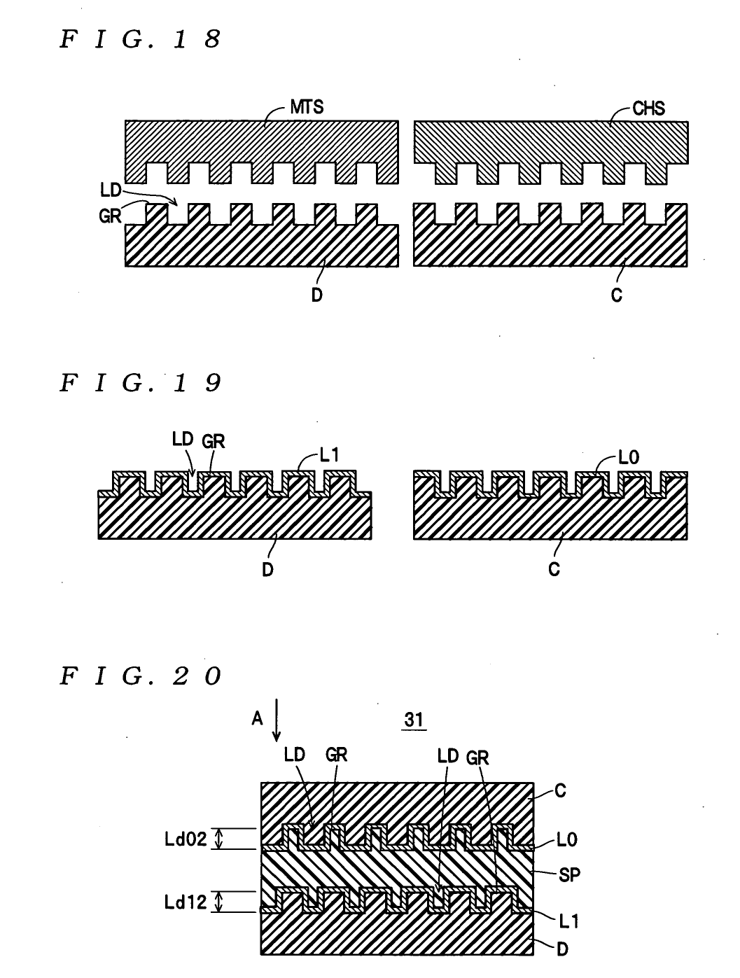

Also, by using the substrate D and the stamper RS fabricated by the embodiments described above, it is possible to manufacture a spacer layer SP composed of two or more light transmitting resin layers. In this case, as shown in FIG. 12, the applied liquid R1 for a light transmitting resin is dripped onto the surface of the stamper RS on which the fine protrusion/depression pattern is formed and the applied liquid R1 is applied across the entire region of the surface of the stamper RS by spin coating. Next, the applied liquid R1 is hardened. More specifically, when a UV curable resin is used as the applied liquid R1, the applied liquid R1 is irradiated with UV rays to harden the applied liquid R1. At this time, in accordance with the transfer characteristics from the stamper RS described above, the depth Ld01 of the lands LD formed in the spacer layer SP is shallower than the depth DPRS of the fine protrusion/depression pattern of the stamper RS. Next, as shown in FIG. 13, the applied liquid R2 made of a light transmitting resin is dripped onto the surface of the substrate D on which the recording layer L1 is formed and the applied liquid R2 is applied across the entire region of the surface of the substrate D by spin coating. Next, as shown in FIG. 14, the applied liquid R1 and the applied liquid R2 are placed in close contact so as to stick the stamper RS to the substrate D. More specifically, when the UV-curable light transmitting adhesive resin is used as the applied liquid R2, the applied liquid R2 is irradiated by UV rays from the stamper RS side and is hardened to stick the stamper RS to the substrate D.

Next, the stamper RS is separated from the substrate D. By doing so, as shown in FIG. 15, a spacer layer SP, which is composed of a two-layer resin construction including the applied liquid R1 and the applied liquid R2 and has a fine protrusion/depression pattern of the grooves GR and lands LD formed (transferred) in a surface of a resin layer composed of the applied liquid R1, is completed. Also, by using this kind of fabrication process, the depth Ld01 of the lands LD of the spacer layer SP is formed definitely shallower than the depth Ld11 of the lands LD of the substrate D and is formed at the same (or approximately the same) depth as the depth Ld02 of the lands LD formed in the surface of the spacer layer SP of the multilayer optical recording medium 31. According to this fabrication process of the spacer layer SP, it is possible to apply resins with different characteristics to the substrate D and the stamper RS. This means that it is possible to use resins that are suitable for the recording layer L1 and the recording layer L0. It should be noted that it is also possible to use a fabrication process in which the applied liquid R2 applied onto the substrate D side is hardened, a UV curable light transmitting adhesive resin is applied onto the stamper RS side as the applied liquid R1, and the applied liquid R1 is hardened after the substrate D and the stamper RS are placed on one another.

Also, it is possible to manufacture a multilayer optical recording medium 11 using a different method of manufacturing to the above method using two types of master stamper MSS11, MSS12 with inphase fine protrusion/depression patterns of different depths. According to this method of manufacturing, in place of the method of manufacturing described above that uses a stamper RS made of resin, the method of manufacturing that manufactures the multilayer optical recording medium 31 is used to manufacture the multilayer optical recording medium 1 where the depth Ld11 of the lands LD of the substrate D is deeper than the depth Ld01 of the lands LD of the spacer layer SP. More specifically, using both master stamper MSS11, MSS12, two mother stampers MTS11, MTS12 in whose surfaces reversed fine protrusion/depression patterns of different depths are formed, are fabricated from a metal material. Next, out of the two fabricated mother stampers MTS11, MTS12, the mother stamper MTS12 with the shallower reversed fine protrusion/depression pattern is used to fabricate a child stamper CHS11, in whose surface an inphase fine protrusion/depression pattern is formed (transferred), from a metal material. In this case, the mother stamper MTS11 composes a forty-first stamper for the present invention and the child stamper CHS11 composes a forty-second stamper for the present invention.

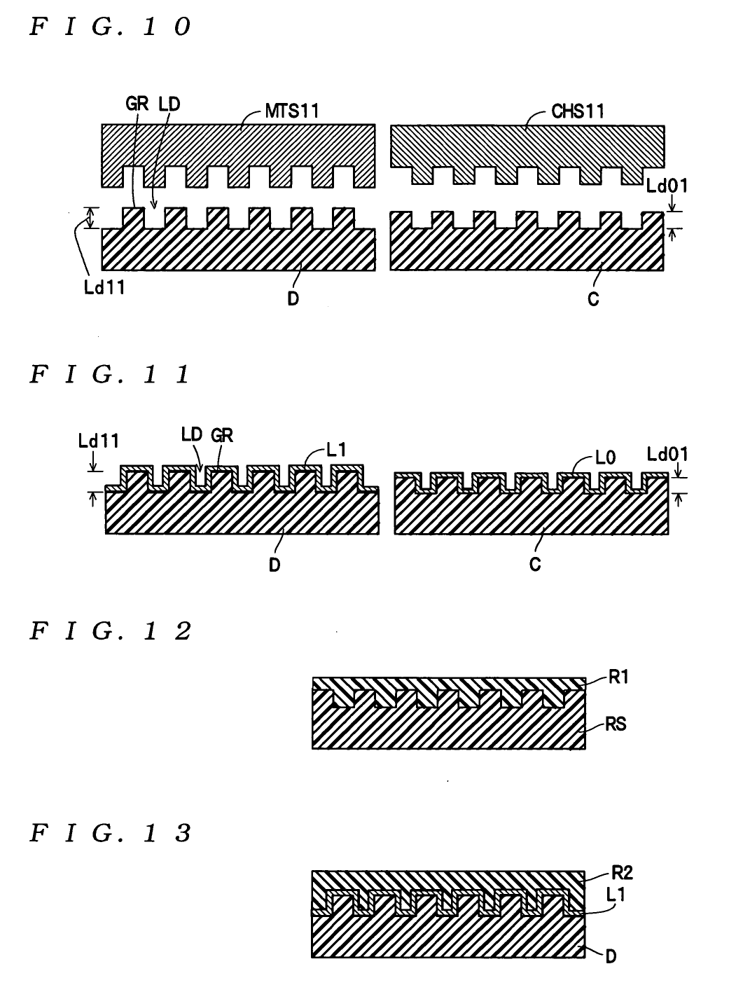

Next, as shown in FIG. 10, a pattern is transferred from the mother stamper MTS11 to fabricate the substrate D and a pattern is transferred from the child stamper CHS11 to fabricate the cover layer C. After this, as shown in FIG. 11, in the same way as the method of manufacturing the multilayer optical recording medium 31 described in the background art, the recording layer L1 is formed on the grooves GR and lands LD of the fabricated substrate D and the recording layer L0 is formed on the surface of the cover layer C in which the fine protrusion/depression pattern is formed. Finally, as shown in FIG. 9, the substrate D and the cover layer C are placed so that the respective surfaces in which the fine protrusion/depression patterns are formed face each other and are stuck together using an adhesive made of light transmitting resin. In this case, the adhesive layer formed by the adhesive made of light transmitting resin composes the spacer layer SP as a light transmitting layer. In this state, the recording layer L1 on the substrate D and the recording layer L0 on the cover layer C (the spacer layer SP) have inphase fine protrusion/depression patterns with the same orientation with respect to the orientation of the incident light. By carrying out the above process, the multilayer optical recording medium 11 is manufactured. In this multilayer optical recording medium 11, the depth Ld01 of the lands LD formed in the surface of the cover layer C (the spacer layer SP) is equal to the depth Ld02 of the lands LD formed in the surface of the cover layer C (the spacer layer SP) of the multilayer optical recording medium 31, and the depth Ld11 of the lands LD formed in the surface of the substrate D is reliably formed deeper than the depth Ld12 of the lands LD formed in the substrate D of the multilayer optical recording medium 31.

It is also possible to compose the respective recording layers L0, L1 of write-once recording layers or read-only layers. It is also possible to apply the invention to a part of the DVD family that includes a plurality of recording layers and/or a plurality of read-only layers.

The substrate D is also not limited to a disc-shape, and can be formed in a variety of shapes, such as a rectangle, a polygon, and an oval. Also, in the embodiments of the present invention, examples of a multilayer optical recording medium 1 including two recording layers L1, L0 are described, but the present invention can be effectively applied to a multilayer optical recording medium with three or more recording layers. This multilayer optical recording medium includes a substrate D, that has guide grooves (the grooves GR and lands LD) for tracking purposes formed on a surface thereof on an incident side for a laser beam, the guide grooves having a recording layer formed on a surface thereof, and also includes two or more light transmitting layers that also have guide grooves (the grooves GR and lands LD) for tracking purposes formed in a surface thereof, the guide grooves having another recording layer formed on a surface thereof and the light transmitting layers being formed above the substrate D, with the respective grooves GR being formed as deeper the closer the grooves are positioned to the substrate D. Putting this another way, this multilayer optical recording medium has a structure wherein the depth of the lands LD that are formed in the incident surface of the light transmitting layer (the spacer layer SP), which is positioned on an incident side on the optical path of the laser beam, is the shallowest, the depths of the lands LD of the respective spacer layers SP become progressively deeper moving towards the substrate D, and the depth of the lands LD formed in a surface of the substrate D on which the laser beam is incident is the deepest. Also, there are no particular limitations on the materials of the respective metal stampers and the respective resin stampers, and the materials can be selected as appropriate. Also, although an example of a construction where the recording layer L1 includes a reflective film has been described in the respective embodiments of the present invention, the presence of a reflective film in the recording layer L1 is not essential for the present invention, and the reflectivity and the refractive index of the substrate D and of the respective layers can be appropriately adjusted to produce a multilayer construction where a sufficient amount of reflected light that does not hinder recording and reproduction is obtained when the recording layer L1 reflects a laser beam. Also, although an example that uses a method of forming the cover layer C by spin coating the recording layer L0 with an applied liquid RC for a light transmitting resin and then hardening the applied liquid RC has been described in the above embodiments of the present invention, it is possible to use a method that forms the cover layer by sticking on a light transmitting resin sheet via a light transmitting adhesive layer. In this case, it is possible to use a polycarbonate resin sheet that is around 50 to 100 μm thick, for example, as the resin sheet and a UV curable adhesive, for example, as the light transmitting adhesive layer.

### INDUSTRIAL APPLICABILITY

As described above, according to this multilayer optical recording medium, since the guide grooves are formed deeper the closer the guide grooves are positioned to the substrate, or in other words, the guide grooves of a light transmitting layer positioned on the incident side for a laser beam are formed with the shallowest depth and the guide grooves of the substrate are formed with the deepest depth, high signal levels can be maintained for tracking error signals during tracking servos for recording layers that are easily affected by the thickness distribution of the light transmitting layers. Accordingly, since it is possible to improve the S/N ratio of the tracking error signal outputted by an optical pickup during tracking servos for the respective recording layers, it is possible to favorably carry out tracking servos for the respective recording layers in the same way as the tracking servo for the recording layer positioned on the incident side for the laser beam in the incident direction. As a result, a multilayer optical recording medium for which the recording of data on all of the recording layers and the reading of data from all of the recording layers can be carried out favorably is realized.

1. A multilayer optical recording medium comprising:
a substrate that has guide grooves for tracking purposes formed on a surface thereof on an incident side for a laser beam, the guide grooves having a recording layer formed on a surface thereof; and
at least one light transmitting layer that also has guide grooves for tracking purposes formed in respective surfaces thereof, the guide grooves having at least one other recording layer formed on a surface thereof and the at least one light transmitting layer being formed above the substrate,
wherein the guide grooves are formed deeper the closer the guide grooves are positioned to the substrate.

2. A method of manufacturing a multilayer optical recording medium that uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate,
the stamper fabricating step comprising at least a step of fabricating a resin stamper, in which a reversed fine protrusion/depression pattern with a reversed orientation to a protrusion/depression pattern of the guide grooves is formed, by transferring a pattern from a first stamper which is made of metal and in a surface of which a fine protrusion/depression pattern with a same orientation as the protrusion/depression pattern of the guide grooves is formed,
and the method of manufacturing comprising at least:
as an intermediate step of manufacturing the multilayer optical recording medium, a step of fabricating the substrate, in a surface of which the guide grooves are formed, by transferring a pattern from one of a transfer original metal stamper used when the first stamper is fabricated and a metal stamper fabricated by transferring a pattern from the first stamper;
a step of forming the recording layer on the surface of the guide grooves of the fabricated substrate;
a step of applying a light transmitting resin onto a surface of the formed recording layer;
a step of forming a light transmitting layer, in which the guide grooves are formed, by transferring a pattern from the resin stamper onto a surface of the applied light transmitting resin; and
a step of forming the other recording layer on the surface of the guide grooves of the formed light transmitting layer.

3. A method of manufacturing a multilayer optical recording medium that uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate,
the stamper fabricating step comprising at least:
a step of fabricating a twelfth stamper, in which a reversed fine protrusion/depression pattern with a reversed orientation to a protrusion/depression pattern of the guide grooves is formed, by transferring a pattern from an eleventh stamper, which is made of metal and in whose surface a fine protrusion/depression pattern with a same orientation as a protrusion/depression pattern of the guide grooves is formed, to a metal material an odd number of times;
a step of fabricating a thirteenth stamper, in which a fine protrusion/depression pattern with a same orientation as the protrusion/depression pattern of the guide grooves is formed, by transferring a pattern from the eleventh stamper to a metal material an even number of times; and
a step of fabricating a resin stamper, in which a reversed fine protrusion/depression pattern with a reversed orientation to the protrusion/depression pattern of the guide grooves is formed, by transferring a pattern from the thirteenth stamper,
and the method of manufacturing comprising at least:
as an intermediate step of manufacturing the multilayer optical recording medium, a step of manufacturing the substrate, in whose surface the guide grooves are formed, by transferring a pattern from a twelfth stamper;
a step of forming the recording layer on the surface of the guide grooves in the fabricated substrate;
a step of applying a light transmitting resin onto a surface of the formed recording layer;
a step of forming a light transmitting layer in which the guide grooves are formed by transferring a pattern from the resin stamper onto a surface of the applied light transmitting resin; and
a step of forming the other recording layer on the surface of the guide grooves of the formed light transmitting layer.

4. A method of manufacturing a multilayer optical recording medium that uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate,
the stamper fabricating step comprising at least:
a step of fabricating a twenty-second stamper, in which a fine protrusion/depression pattern with a same orientation as a protrusion/depression pattern of the guide grooves is formed, by transferring a pattern from a twenty-first stamper, which is made of metal and in a surface of which a reversed fine protrusion/depression pattern with a reversed orientation to the protrusion/depression pattern of the guide grooves is formed, an odd number of times onto a metal material;
a step of fabricating a twenty-third stamper, in which a reversed fine protrusion/depression pattern with a reversed orientation to the protrusion/depression pattern of the guide grooves is formed, by transferring a pattern an even number of times from the twenty-first stamper to a metal material; and
a step of manufacturing a resin stamper, in which a reversed fine protrusion/depression pattern with a reversed orientation to the protrusion/depression pattern of the guide grooves is formed, by transferring a pattern from the twenty-second stamper,
and the method of manufacturing comprising at least:
as an intermediate step of manufacturing the multilayer optical recording medium, a step of manufacturing the substrate, in whose surface the guide grooves are formed, by transferring a pattern from a twenty-third stamper;
a step of forming the recording layer on the surface of the guide grooves in the fabricated substrate;
a step of applying a light transmitting resin onto a surface of the formed recording layer;
a step of forming a light transmitting layer, in which the guide grooves are formed, by transferring a pattern from the resin stamper onto a surface of the applied light transmitting resin; and
a step of forming the other recording layer on the surface of the guide grooves of the formed light transmitting layer.

5. A method of manufacturing a multilayer optical recording medium that uses a stamper fabricated by a stamper fabricating step to manufacture a multilayer optical recording medium including a substrate that has guide grooves for tracking purposes formed on a surface thereof on an incident side for a laser beam, the guide grooves having a recording layer formed on a surface thereof, and a light transmitting layer that also has guide grooves for tracking purposes formed in a surface thereof, the guide grooves having another recording layer formed on a surface thereof and the light transmitting layer being formed above the substrate,
the stamper fabricating step comprising at least a step of fabricating a resin stamper, in which a reversed fine protrusion/depression pattern with a reversed orientation to the protrusion/depression pattern of the guide grooves is formed, by transferring a pattern from a thirty-second stamper, which is made of metal and in a surface of which a fine protrusion/depression pattern with a same orientation as the protrusion/depression pattern of the guide grooves is formed more shallowly than a fine protrusion/depression pattern of a thirty-first stamper, which is made of metal and in which a reversed fine protrusion/depression pattern with a reversed orientation to the protrusion/depression pattern of the guide grooves is formed,
and the method of manufacturing comprising at least:
as an intermediate step of manufacturing the multilayer optical recording medium, a step of fabricating the substrate, in whose surface the guide grooves are formed, by transferring a pattern from a thirty-first stamper;
a step of forming the recording layer on the surface of the guide grooves in the fabricated substrate;
a step of applying a light transmitting resin onto a surface of the formed recording layer;
a step of forming a light transmitting layer, in which the guide grooves are formed, by transferring a pattern from the resin stamper onto a surface of the applied light transmitting resin; and
a step of forming the other recording layer on the surface of the guide grooves of the formed light transmitting layer.

6. A method of manufacturing a multilayer optical recording medium composed of a substrate that has guide grooves for tracking purposes formed on a surface thereof on an incident side for a laser beam, the guide grooves having a recording layer formed on a surface thereof, a light transmitting layer that also has guide grooves for tracking purposes formed in a surface thereof, the guide grooves having another recording layer formed on a surface thereof, and a cover layer that transmits light, the light transmitting layer and the cover layer being formed above the substrate,
the method of manufacturing comprising at least:
as an intermediate step of manufacturing the multilayer optical recording medium, a step of manufacturing the substrate, in whose surface the guide grooves are formed, by transferring a pattern from a forty-first stamper which is made of metal and in which a reversed fine protrusion/depression pattern with a reversed orientation to a protrusion/depression pattern of the guide grooves is formed;
a step of fabricating the cover layer, in which a reversed fine protrusion/depression pattern with a reversed orientation to a protrusion/depression pattern of the guide grooves is formed, by transferring a pattern from a forty-second stamper, which is made of metal and in which a fine protrusion/depression pattern with a same orientation as the protrusion/depression pattern of the guide grooves is formed shallower than the reversed fine protrusion/depression pattern of the forty-first stamper;
a step of forming the respective recording layers on the surface of the guide grooves formed in the fabricated substrate and the surface of the reversed fine protrusion/depression pattern of the fabricated cover layer; and
a step of integrating, via a light transmitting adhesive resin as the light transmitting layer, the substrate and the cover layer in a state where the respective recording layers thereon face one another, and transferring a pattern of the cover layer to a surface of light transmitting adhesive resin to form the guide grooves.
